(19) United States
(12) Patent Application Publication
(10) Pub. No.: US 2011/0157074 A1
(43) Pub. Date: Jun. 30, 2011

(54) TOUCH DETECTING DEVICE AND METHOD

(76) Inventors: Kun-Chih Lin, Hsinchu City (TW); Yu-Chang Lo, Hsinchu County (TW)

(21) Appl. No.: 12/850,517

(22) Filed: Aug. 4, 2010

(30) Foreign Application Priority Data
Dec. 24, 2009 (TW) 098144761

(51) Int. Cl. G06F 3/045

(52) U.S. Cl. 345/174

(57) ABSTRACT

A touch detecting device for a capacitive touch sensor that includes a plurality of sensing units aligned along a predetermined direction, includes a differential detecting module and a processing module. The differential detecting module is configured to detect a capacitance variation between each two adjacent ones of the sensing units so as to generate a sequence of capacitance variations. The processing module is configured to determine a number of transitions corresponding to a number of touched areas on the capacitive touch sensor, where the number of transitions is one or greater. Each of the transitions represents a change from one of a set of the capacitance variations that is positive to one of a succeeding set of the capacitance variations that is negative. A touch detecting method is also disclosed.

### CROSS-REFERENCE TO RELATED APPLICATION

This application claims priority of Taiwanese Application No. 098144761, filed on Dec. 24, 2009.

### BACKGROUND OF THE INVENTION

1. Field of the Invention

This invention relates to a touch detecting device and a touch detecting method capable of detecting at least one touch area on a capacitive touch sensor.

2. Description of the Related Art

Touch sensors are becoming widely used in electronic products to serve as input devices.

U.S. Pat. No. 5,825,352 discloses a conventional touch detecting method for a two-dimensional capacitive touch sensor 1 (see FIGS. 1 and 2). The capacitive touch sensor 1 includes a plurality of first sensing units 11 aligned along a first direction (X), and a plurality of second sensing units 12 aligned along a second direction (Y) transverse to the first direction (X). Each of the first and second sensing units 11, 12 has a capacitance that can be varied when touched by a user's finger. For each of the first and second directions (X, Y), the touch detecting method detects a capacitance of each of the sensing units 11, 12 so as to generate a sequence of capacitances, from which a touch profile 22, 23 of capacitance is drawn, finds at least one maximum capacitance from the sequence of the capacitances to obtain a number of the maximum capacitances corresponding to a number of touched areas 21 on the capacitive touch sensor 1, finds at least one centroid of the touch profile 22, 23 based on the sequence of the capacitances and sequentially ordered indices corresponding to the sequence of the capacitances, respectively, and obtains the location of the touched areas 21 based on the centroid. For example, the touch profile shown in FIG. 2(a) shows that there is only one maximum capacitance 24, which indicates that the number of the touch areas 21 in the corresponding one of the first and second directions (X, Y) is one. The touch profile shown in FIG. 2(b) shows that there are two maximum capacitances 24, which indicates that the number of the touch areas 21 in the corresponding one of the first and second directions (X, Y) is two. However, detection of the capacitance of each of the first and second units 11, 12 is sensitive to noise, which can degrade the accuracy of the detected capacitance.

In order to solve the aforesaid problem, another conventional touch detecting method is disclosed and differs from the aforesaid touch detecting method in that it detects a capacitance variation between each two adjacent ones of the sensing units 11, 12 so as to generate a sequence of capacitance variations, and then integrates the capacitance variations so as to generate a sequence of capacitances. The capacitances thus obtained are used to determine the number of the touched areas 21 and the location of the touch areas 21 in a manner similar to that of the previous conventional method. Although the method can solve the aforesaid problem, the integration operation requires additional hardware and/or software resources and power as compared to the previous conventional method.

### SUMMARY OF THE INVENTION

Therefore, the object of the present invention is to provide a touch detecting device and a touch detecting method that can overcome the aforesaid drawbacks associated with the prior art.

According to one aspect of this invention, there is provided a touch detecting device for a capacitive touch sensor that includes a plurality of sensing units aligned along a predetermined direction. The touch detecting device includes a differential detecting module and a processing module. The differential detecting module is adapted to be coupled electrically to the capacitive touch sensor and is configured to detect a capacitance variation between each two adjacent ones of the sensing units so as to generate a sequence of capacitance variations. The processing module is coupled electrically to the differential detecting module and is configured to determine a number of transitions corresponding to a number of touched areas on the capacitive touch sensor, where the number of transitions is one or greater. Each of the transitions represents a change from one of a set of the capacitance variations that is positive to one of a succeeding set of the capacitance variations that is negative, where the number of the capacitance variations of the set or the succeeding set is one or greater. The capacitance variations of the set or the succeeding set are in a sequential order according to the sequence of the capacitance variations when the number of the capacitance variations of the set or the succeeding set is greater than one.

According to another aspect of this invention, there is provided a touch detecting method for a capacitive touch sensor that includes a plurality of sensing units aligned along a predetermined direction. The touch detecting method includes: detecting a capacitance variation between each two adjacent ones of the sensing units so as to generate a sequence of capacitance variations; and determining a number of transitions corresponding to a number of touched areas on the capacitive touch sensor, where the number of transitions is one or greater. Each of the transitions represents a change from one of a set of the capacitance variations that is positive to one of a succeeding set of the capacitance variations that is negative, where the number of the capacitance variations of the set or the succeeding set is one or greater. The capacitance variations of the set or the succeeding set are in a sequential order according to the sequence of the capacitance variations when the number of the capacitance variations of the set or the succeeding set is greater than one.

### BRIEF DESCRIPTION OF THE DRAWING

Other features and advantages of the present invention will become apparent in the following detailed description of the preferred embodiment of this invention, with reference to the accompanying drawings, in which:

FIG. 1 is a schematic view of a two-dimensional capacitive touch sensor with two touch profiles of detected capacitances along first and second directions, respectively, obtained according to a conventional method;

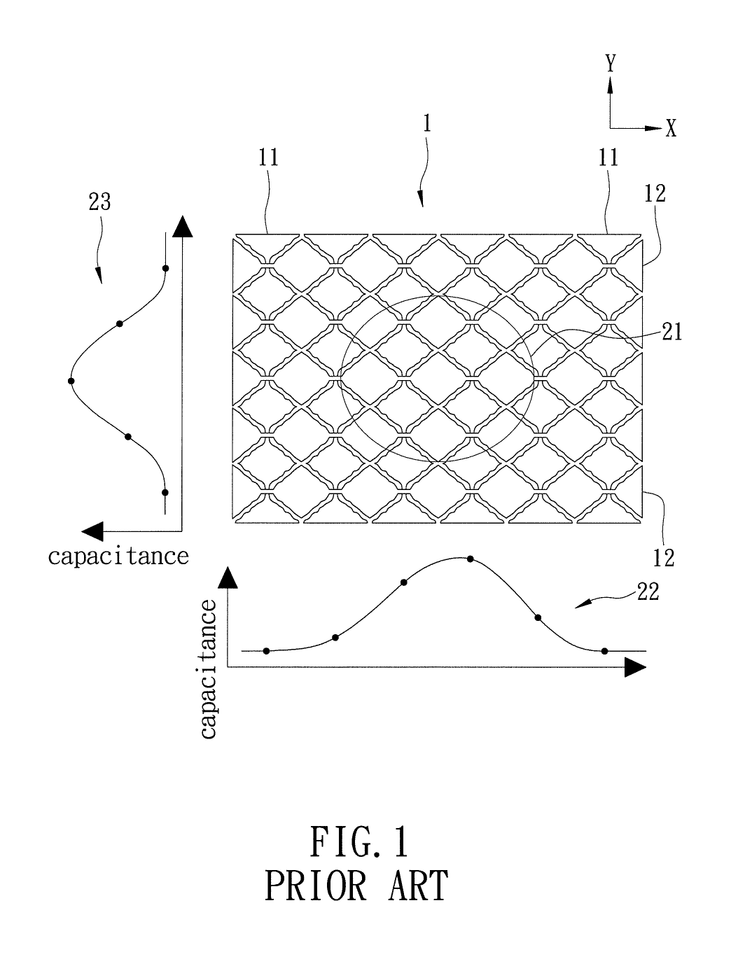

FIG. 2 is a schematic view illustrating (a) a touch profile of detected capacitances in response to a one-finger touch on the capacitive touch sensor, and (b) a touch profile of detected capacitances in response to a two-finger touch on the capacitive touch sensor, obtained according to the conventional method;

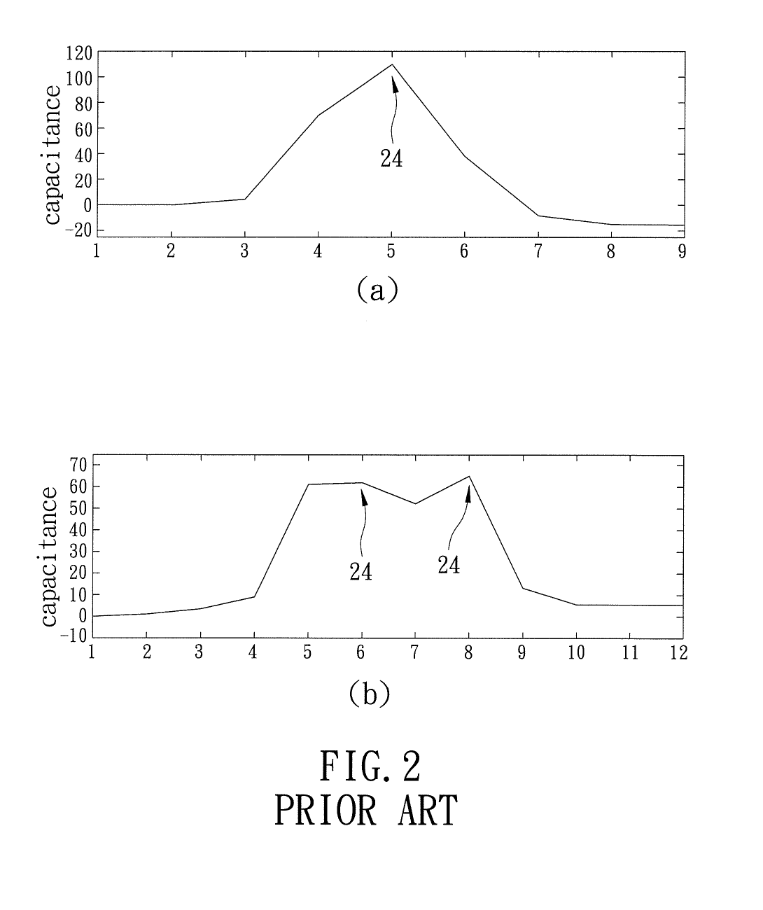

FIG. 3 is a schematic view of a two-dimensional capacitive touch sensor with two touch profiles of detected capacitance variations along first and second directions, respectively;

FIG. 4 is a block diagram of the preferred embodiment of a touch detecting device coupled to the capacitive touch sensor according to this invention;

FIG. 5 is a flow chart of the preferred embodiment of a touch detecting method according to this invention;

FIG. 6 is a schematic view illustrating (a) a touch profile of detected capacitance variations of the preferred embodiment in response to a one-finger touch on the capacitive touch sensor, and (b) the touch profile with a zero crossing point determined by a mathematical scheme; and

FIG. 7 is a schematic view illustrating (a) a touch profile of detected capacitance variations of the preferred embodiment in response to a two-finger touch on the capacitive touch sensor, and (b) a high resolution touch profile determined from the detected capacitance variations by an interpolation scheme.

### DETAILED DESCRIPTION OF THE PREFERRED EMBODIMENTS

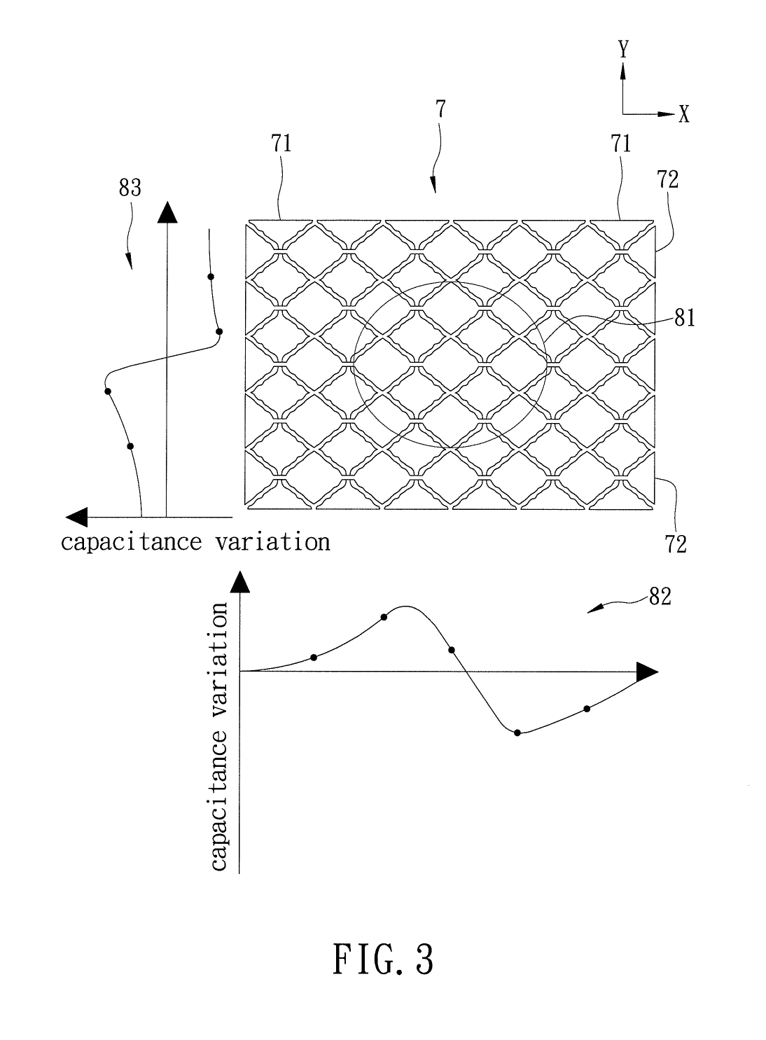

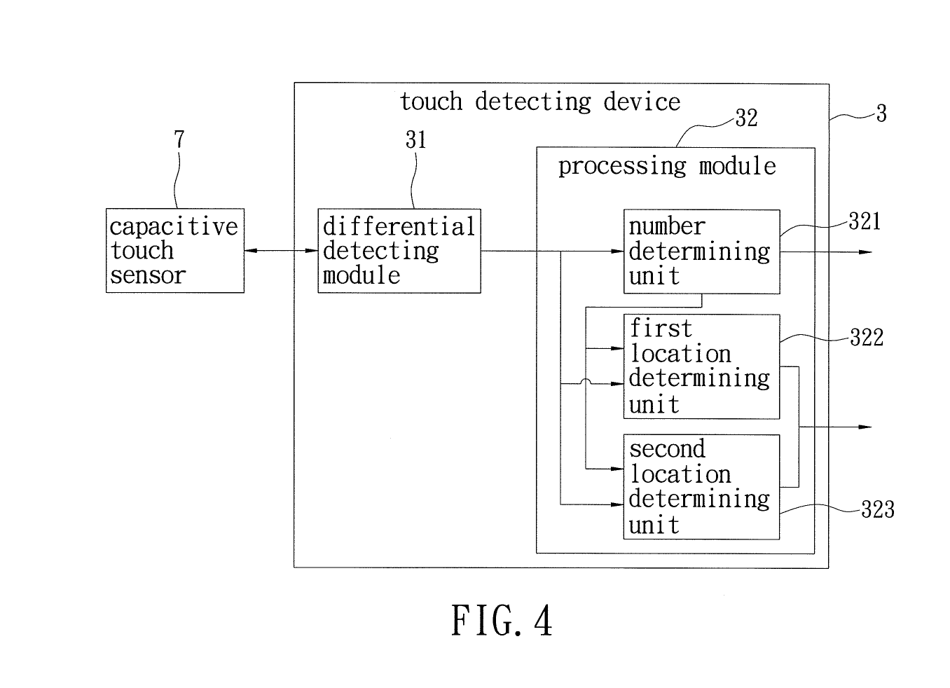

Referring to FIGS. 3 and 4, the preferred embodiment of a touch detecting device 3 according to this invention for a capacitive touch sensor 7 includes a differential detecting module 31 adapted to be coupled electrically to the capacitive touch sensor 7, and a processing module 32 coupled electrically to the differential detecting module 31. The processing module 32 includes a number determining unit 321, a first location determining unit 322 and a second location determining unit 323. The capacitive touch sensor 7 includes a plurality of sensing units 71, 72 aligned along first and second predetermined directions (X, Y), respectively.

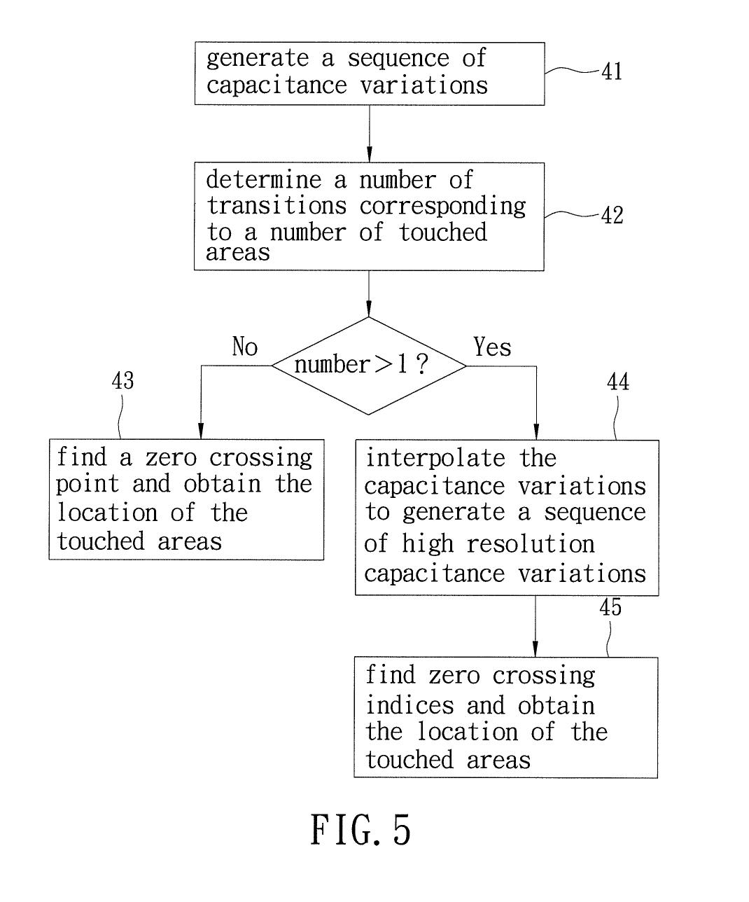

Referring to FIG. 5, in combination with FIGS. 3 and 4, a touch detecting method according to a preferred embodiment of the present invention and implemented in the touch detecting device 3 for determining the location of touch areas 81 on the capacitive touch sensor 7 in each of the first and second predetermined directions (X, Y) includes the following steps.

In step 41, the differential detecting module 31 is configured to detect a capacitance variation between each two adjacent ones of the sensing units 71, 72 so as to generate a sequence of capacitance variations, from which a touch profile of capacitance variation 82, 83 can be drawn.

In step 42, the number determining unit 321 of the processing module 31 is configured to determine a number of transitions corresponding to a number of the touched areas 81 on the capacitive touch sensor 1, i.e., a number of the touched areas 81 in the corresponding one of the first and second predetermined directions (X, Y), where the number of transitions is one or greater. Each of the transitions represents a change from one of a set of the capacitance variations that is positive to one of a succeeding set of the capacitance variations that is negative, where the number of the capacitance variations of the set or the succeeding set is one or greater. The capacitance variations of the set or the succeeding set are in a sequential order according to the sequence of the capacitance variations when the number of the capacitance variations of the set or the succeeding set is greater than one.

In this embodiment, the number determining unit 321 is configured to find at least one pair of a local maximum capacitance variation that is positive and a succeeding local minimum capacitance variation that is negative from the capacitance variations, and to obtain the number of the transitions based on the number of the pairs of the local maximum and minimum capacitance variations.

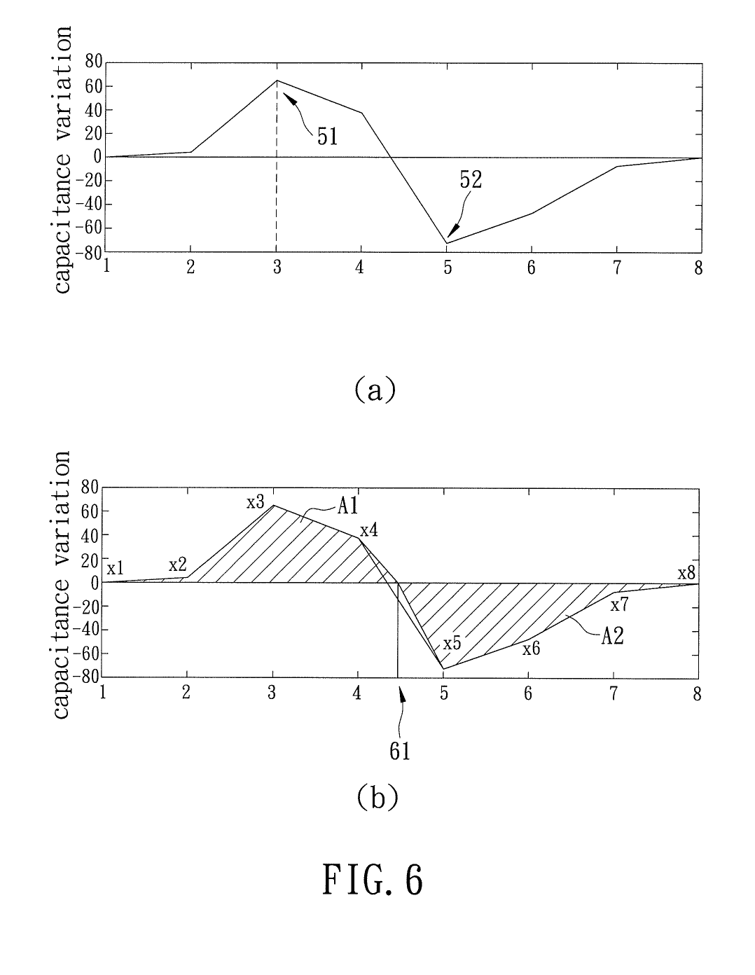

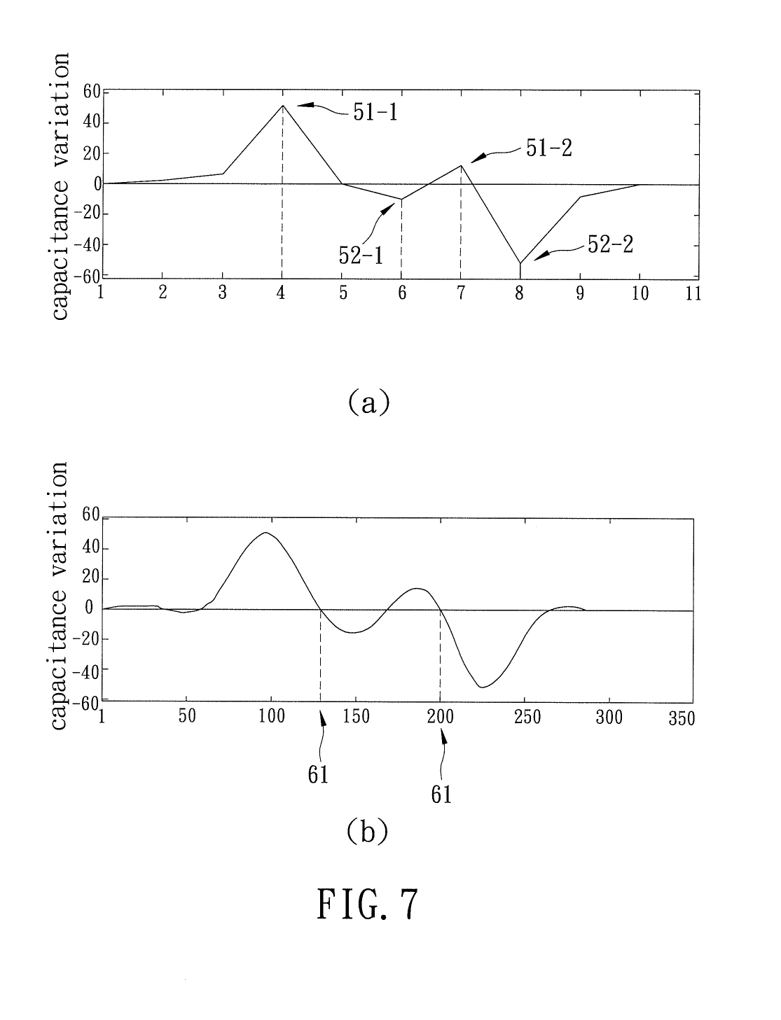

For example, the touch profile of capacitance variation shown in FIG. 6(a) shows that there is only one pair of the local maximum and minimum capacitance variations 51, 52, which indicates that the number of the transitions is one, i.e., the number of the touch areas 81 in the corresponding one of the first and second predetermined directions (X, Y) is one. The touch profile of capacitance variation shown in FIG. 7(a) shows that there are two pairs of the local maximum and minimum capacitance variations 51, 52, where one pair is labeled as 51-1 and 52-1, and the other pair is labeled as 51-2 and 52-2, which indicates the number of the transitions is two, i.e., the number of the touch areas 81 in the corresponding one of the first and second predetermined directions (X, Y) is two.

If the number of the transitions determined by the number determining unit 321 in step 42 is one, the flow proceeds to step 43, and if the number of the transitions determined by the number determining unit 321 in step 42 is greater than one, the flow proceeds to step 44.

In step 43, the first location determining unit 322 of the processing module 32 is configured to find a zero crossing point, and to obtain the location of the touched areas 81 based on the zero crossing point when the number of the transitions determined by the number determining unit 321 in step 42 is one. The zero crossing point is determined by equating a first area defined by a ridge of a trajectory, along which the capacitance variations are distributed at equal intervals with sequentially ordered first indices that define an axis, immediately preceding the zero crossing point and the axis of the first indices to a second area defined by the axis of the first indices and a valley of the trajectory immediately following the zero crossing point.

For example, the touch profile of capacitance variation shown in FIG. 6(b) shows that points x1 to x8 corresponding to the detected capacitance variations with the corresponding first indices 1 to 8, respectively, that the first area is an area of the ridge (the shaded area (A1) in FIG. 6(b)) immediately before the zero crossing point 61, and that the second area is an area of the valley (the shaded area (A2) in FIG. 6(b)) immediately after the zero crossing point 61.

In step 44, the second location determining unit 323 of the processing module 32 is configured to interpolate the capacitance variations to generate a sequence of high resolution capacitance variations.

In step 45, the second location determining unit 323 of the processing module 32 is configured to find zero crossing indices from sequentially ordered second indices corresponding to the sequence of the high resolution capacitance variations, respectively, and to obtain the location of the touched areas 81 based on the zero crossing indices when the number of the transitions determined by the number determining unit 321 instep 42 is greater than one. Each of the zero crossing indices corresponds to one of the high resolution capacitance variations that is substantially zero, and is located between two of the sequentially ordered indices that correspond to the local maximum and minimum capacitance variations , respectively.

For example, the capacitance variations of the touch profile shown in FIG. 7(a) are interpolated to generate a touch profile of the high resolution capacitance variations with two zero crossing indices 61 shown in FIG. 7(b).

It is noted that in another embodiment, the first location determining unit 322 and step 43 can be omitted, and the second location determining unit 323 and step 44 are used to determine the location of the touched areas 81 both when the number of the transitions is one and greater than one.

The touch detecting device 3 may be implemented in different ways. For example, the touch detecting device 3 can be implemented in hardware, such as through use of an integrated circuit, the differential detecting module 31 of the touch detecting device 3 can be implemented in hardware, such as through use of an integrated circuit, and the processing module 32 of the touch detecting device 3 can be implemented in software or firmware.

In sum, by detecting the capacitance variation between each two adjacent ones of the sensing units 71, 72 and by determining the number of the transitions, the aforesaid drawbacks associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A touch detecting device for a capacitive touch sensor that includes a plurality of sensing units aligned along a predetermined direction, said touch detecting device comprising:
a differential detecting module adapted to be coupled electrically to the capacitive touch sensor and configured to detect a capacitance variation between each two adjacent ones of the sensing units so as to generate a sequence of capacitance variations; and
a processing module coupled electrically to said differential detecting module and configured to determine a number of transitions corresponding to a number of touched areas on the capacitive touch sensor, where the number of transitions is one or greater, each of the transitions representing a change from one of a set of the capacitance variations that is positive to one of a succeeding set of the capacitance variations that is negative, where the number of the capacitance variations of the set or the succeeding set is one or greater, the capacitance variations of the set or the succeeding set being in a sequential order according to the sequence of the capacitance variations when the number of the capacitance variations of the set or the succeeding set is greater than one.

2. The touch detecting device of claim 1, wherein said processing module is configured to find at least one pair of a local maximum capacitance variation that is positive and a succeeding local minimum capacitance variation that is negative from the capacitance variations, and to obtain the number of the transitions based on the number of the pairs of the local maximum and minimum capacitance variations.

3. The touch detecting device of claim 2, wherein said processing module is further configured to interpolate the capacitance variations to generate a sequence of high resolution capacitance variations, and to find at least one zero crossing index from sequentially ordered indices corresponding to the sequence of the high resolution capacitance variations, respectively, the zero crossing index corresponding to one of the high resolution capacitance variations that is substantially zero, and being located between two of the sequentially ordered indices that correspond to the local maximum and minimum capacitance variations, respectively, said processing module being further configured to obtain the location of the touched areas based on the zero crossing index.

4. The touch detecting device of claim 2, wherein said processing module is further configured to find a zero crossing point, and to obtain the location of the touched areas based on the zero crossing point, the zero crossing point being determined by equating an area defined by a ridge of a trajectory, along which the capacitance variations are distributed at equal intervals with sequentially ordered indices that define an axis, immediately preceding the zero crossing point and the axis of the indices to an area defined by the axis of the indices and a valley of the trajectory immediately following the zero crossing point.

5. A touch detecting method for a capacitive touch sensor that includes a plurality of sensing units aligned along a predetermined direction, the touch detecting method comprising:
(a) detecting a capacitance variation between each two adjacent ones of the sensing units so as to generate a sequence of capacitance variations; and
(b) determining a number of transitions corresponding to a number of touched areas on the capacitive touch sensor, where the number of transitions is one or greater, each of the transitions representing a change from one of a set of the capacitance variations that is positive to one of a succeeding set of the capacitance variations that is negative, where the number of the capacitance variations of the set or the succeeding set is one or greater, the capacitance variations of the set or the succeeding set being in a sequential order according to the sequence of the capacitance variations when the number of the capacitance variations of the set or the succeeding set is greater than one.

6. The touch detecting method of claim 5, wherein step (b) includes:
finding at least one pair of a local maximum capacitance variation that is positive and a succeeding local minimum capacitance variation that is negative from the capacitance variations; and
obtaining the number of the transitions based on the number of the pairs of the local maximum and minimum capacitance variations.

7. The touch detecting method of claim 6, further comprising:
(c) interpolating the capacitance variations to generate a sequence of high resolution capacitance variations; and
(d) finding at least one zero crossing index from sequentially ordered indices corresponding to the sequence of the high resolution capacitance variations, respectively, and obtaining the location of the touched areas based on the zero crossing index, the zero crossing index corresponding to one of the high resolution capacitance variations that is substantially zero, and being located between two of the sequentially ordered indices that correspond to the local maximum and minimum capacitance variations, respectively.

8. The touch detecting method of claim 6, further comprising:
(e) finding a zero crossing point, and obtaining the location of the touched areas based on the zero crossing point, the zero crossing point being determined by equating an area defined by a ridge of a trajectory, along which the capacitance variations are distributed at equal intervals with sequentially ordered indices that define an axis, immediately preceding the zero crossing point and the axis of the indices to an area defined by the axis of the indices and a valley of the trajectory immediately following the zero crossing point.
